(19) United States
(12) Patent Application Publication
(10) Pub. No.: US 2024/0417837 A1
(43) Pub. Date: Dec. 19, 2024

(54) METHOD FOR PRODUCING ALUMINUM ALLOY RAW MATERIAL, METHOD FOR PRODUCING ALUMINUM ALLOY INGOT, METHOD FOR PRODUCING ALUMINUM ALLOY PLATE, METHOD FOR PRODUCING ALUMINUM ALLOY SUBSTRATE FOR PLATING, METHOD FOR PRODUCING ALUMINUM ALLOY SUBSTRATE FOR MAGNETIC DISK, METHOD FOR PRODUCING MAGNETIC DISK, AND MAGNETIC DISK

(71) Applicants: UACJ Corporation, Tokyo (JP); Furukawa Electric Co., Ltd., Tokyo (JP)

(72) Inventors: Kotaro KITAWAKI, Tokyo (JP); Yuma KOKUBUN, Tokyo (JP); Ryo SAKAMOTO, Tokyo (JP); Hideyuki HATAKEYAMA, Tokyo (JP)

(73) Assignees: UACJ Corporation, Tokyo (JP); Furukawa Electric Co., Ltd., Tokyo (JP)

(21) Appl. No.: 18/819,375

(22) Filed: Aug. 29, 2024

Related U.S. Application Data
(63) Continuation of application No. PCT/JP2023/007476, filed on Mar. 1, 2023.

(30) Foreign Application Priority Data
Mar. 2, 2022 (JP) 2022-031520

(51) Int. Cl. C22F 1/04; B32B 15/01; C22B 21/00; C23C 18/16; C23C 18/18; C23C 18/50

(52) U.S. Cl. CPC C22F 1/04; C22B 21/0069; C23C 18/1637; C23C 18/1837; C23C 18/50; B32B 15/017; B32B 2311/22; B32B 2311/24

(57) ABSTRACT

An example method for producing an aluminum alloy raw material, wherein in a separation step of reusing, as a recycled material, at least one of an intermediate material and a finished product each comprising an aluminum alloy disk and an underlayer, for at least part of an aluminum alloy material and heating the aluminum alloy material comprising the recycled material to separate the aluminum alloy disk and the underlayer, and the aluminum alloy material comprising the recycled material is heated and held at 480° C. or higher and 590° C. or lower for more than 1 hour.

### CROSS REFERENCE TO RELATED APPLICATIONS

This is a continuation application of International Patent Application No. PCT/JP2023/007476 filed Mar. 1, 2023, which claims the benefit of Japanese Patent Application No. 2022-031520 filed Mar. 2, 2021, as well as the full contents of all of which are hereby incorporated by reference in their entirety.

### BACKGROUND

### Technical Field

The present disclosure relates to a method for producing an aluminum alloy raw material having excellent recyclability, a method for producing an aluminum alloy ingot using this, a method for producing an aluminum alloy plate using this, a method for producing an aluminum alloy substrate for plating using this, a method for producing an aluminum alloy substrate for a magnetic disk using this, a method for producing a magnetic disk using this, and a magnetic disk obtained by the method.

### Description of the Related Art

An aluminum alloy magnetic disk used for a memory device of a computer is produced from an aluminum alloy substrate using, as a base, a JIS 5086-series aluminum alloy not only having good platability but also having excellent mechanical characteristics and processability.

Furthermore, the aluminum alloy magnetic disk is produced from an aluminum alloy substrate in which contents of Fe, Si, Mn and the like that are impurities in the JIS 5086-series aluminum alloy have been limited, and in which sizes of intermetallic compounds in a matrix have been reduced for the purpose of improving pit defects due to drop-off of the intermetallic compounds during a plating pretreatment step; an aluminum alloy substrate in which Cu and Zn in the JIS 5086-series aluminum alloy have been consciously added for the purpose of improving platability; or the like.

In the production of a common aluminum alloy magnetic disk, an aluminum alloy plate is made first, thereafter an annular aluminum alloy disk blank is made, cutting work and grinding work are performed, and then pressure annealing is performed to make an aluminum alloy substrate. Subsequently, plating is performed on this aluminum alloy substrate, and further, a magnetic body is allowed to adhere to a surface of the aluminum alloy substrate, thereby producing an aluminum alloy magnetic disk.

For example, an aluminum alloy magnetic disk using a JIS 5086-series aluminum alloy is produced through the following steps. First, an aluminum alloy having desired alloy composition is cast, the resulting ingot is subjected to hot rolling, and subsequently, a hot rolled plate obtained is subjected to cold rolling to make a rolled material having a necessary thickness as a magnetic disk. This rolled material is subjected to annealing during the cold rolling or the like, as needed. Thereafter, this rolled material is punched out in an annular shape, then in order to further remove strain or the like generated in the production process, annular aluminum alloy plates are laminated, and pressure annealing to perform annealing and thereby flatten them while applying pressure from both sides is carried out. Through such steps, a disk blank is made.

The disk blank made as above is subjected to cutting work and grinding work as pretreatment, and thereafter, in order to remove strain or the like generated in the work step, the disk blank is heat treated to make an aluminum alloy substrate. Thereafter, on the resulting aluminum alloy substrate, degreasing, etching, and zincate treatment (Zn substitution treatment) are performed as plating pretreatment, then Ni—P plating with hard non-magnetic metals is further performed as surface treatment, and polishing is performed on the surface, thereby making an aluminum alloy substrate for a magnetic disk. Finally, a magnetic body or the like is sputtered to produce a magnetic disk made of an aluminum alloy.

By the way, for magnetic disks, capacity enlargement and densification have been required from the needs of multimedia and the like in recent years. For further capacity enlargement, the number of magnetic disks installed in a memory device increases, and with this, thinning of a magnetic disk has also been required. However, if the aluminum alloy substrate for a magnetic disk is thinned, its rigidity is decreased, so that high rigidity has been required for the aluminum alloy substrate, and in recent years, use of a high-rigidity material in which Ni or the like has been added is being studied.

On the other hand, with an increase in the number of magnetic disks installed, necessary quantities of Al and the like that are raw materials of an aluminum alloy substrate for a magnetic disk are increasing. However, since there is limitation on the resources for these, reuse of an aluminum alloy substrate and a magnetic disk each having plating, a magnetic body and the like attached thereto, as part of raw materials of an aluminum alloy material has been required. As targets for recycling, a material unsuitable as a product because of occurrence of defects is used in the case of an aluminum alloy substrate, and a material extracted from a defective or a used HDD, or the like is used in the case of a magnetic disk.

Under such actual circumstances as above, a method for producing an aluminum alloy ingot having excellent recyclability, a method for producing an aluminum alloy plate using this ingot, a method for producing an aluminum alloy substrate for a magnetic disk using this aluminum alloy plate, and production of a magnetic disk using this aluminum alloy substrate have been eagerly desired, and are being studied in recent years. For example, in Japanese Patent Application Laid-Open No. 2002-275568, it is proposed that by incorporating Ni in an aluminum alloy for a magnetic disk, an aluminum alloy substrate for a magnetic disk, which will be obtained subsequently, can be reused as a raw material.

In the method disclosed in Japanese Patent Application Laid-Open No. 2002-275568, however, when the aluminum alloy substrate for a magnetic disk is used in a large amount as a raw material, for example, when the aluminum alloy substrate for a magnetic disk is used at a weight ratio of 50% or more of the raw material, there is a possibility that 3.0 mass % or more of Ni may be contained in the aluminum alloy raw material. On that account, when an aluminum alloy raw material that cannot be allowed to contain a large amount of Ni is made, a small amount of an aluminum alloy substrate for a magnetic disk can only be used, and lack of recyclability is a matter of concern.

### SUMMARY

The present disclosure is related to providing a method for producing an aluminum alloy raw material having excellent recyclability. Further, the present disclosure is related to providing a method for producing an aluminum alloy ingot, a method for producing an aluminum alloy plate, a method for producing an aluminum alloy substrate for plating, a method for producing an aluminum alloy substrate for a magnetic disk, a method for producing a magnetic disk, and a magnetic disk, each of which uses such an aluminum alloy raw material having excellent recyclability as above.

The present inventors have found that by controlling a heating temperature and a holding time in a separation step of separating an aluminum alloy disk and an underlayer from an intermediate material or a finished product that is a target of recycling, an aluminum alloy raw material having excellent recyclability is obtained, and they have completed the present disclosure.

The method for producing an aluminum alloy raw material according to one embodiment of the present disclosure is a method for producing an aluminum alloy raw material wherein in a separation step of reusing, as a recycled material, at least one of an intermediate material and a finished product each comprising an aluminum alloy disk and an underlayer, for at least part of an aluminum alloy material and heating the aluminum alloy material comprising the recycled material to separate the aluminum alloy disk and the underlayer, the aluminum alloy material comprising the recycled material is heated and held at 480° C. or higher and 590° C. or lower for more than 1 hour.

According to the present disclosure, a method for producing an aluminum alloy raw material having excellent recyclability can be provided. Moreover, by using such an aluminum alloy raw material having excellent recyclability, a method for producing an aluminum alloy ingot, a method for producing an aluminum alloy plate, a method for producing an aluminum alloy substrate for plating, a method for producing an aluminum alloy substrate for a magnetic disk, a method for producing a magnetic disk, and a magnetic disk can be provided.

### BRIEF DESCRIPTION OF DRAWINGS

FIG. 1 is a flow diagram showing a production process for the aluminum alloy raw material according to the present disclosure to a production process for a magnetic disk.

### DETAILED DESCRIPTION

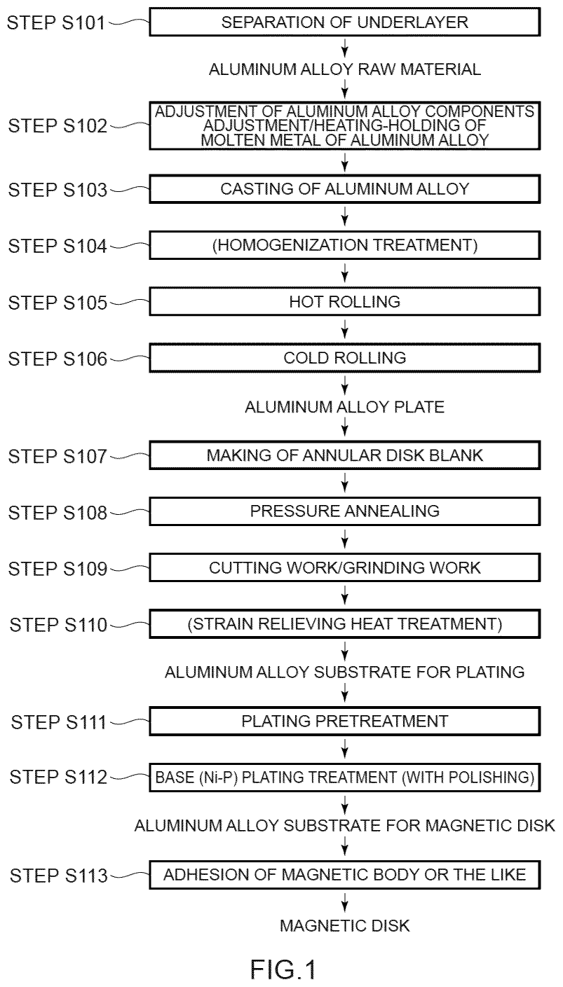

Hereinafter, embodiments of the present disclosure will be described in detail with reference to FIG. 1. In the present disclosure, in a separation step wherein in order to reuse, as a recycled material, at least one of an intermediate material and a finished product each including an aluminum alloy disk and an underlayer for at least part of an aluminum alloy material, the aluminum alloy material including the recycled material is heated to separate the aluminum alloy disk and the underlayer from the intermediate material or the finished product, a heating temperature and a holding time are controlled. The heating temperature and the holding time in the separation step have a major influence on separability of the underlayer, and therefore, by controlling these, an aluminum alloy raw material having excellent recyclability can be obtained. In the present disclosure, by heating and holding the aluminum alloy material including the recycled material at 480° C. or higher and 590° C. or lower for more than 1 hour, a separation ratio between the aluminum alloy disk and the underlayer after the separation step becomes 100% or more, and perfect separation (peeling) of the underlayer becomes possible. A separation ratio exceeding 100% means that not only the under layer but also part of an aluminum alloy peels off from the recycled material.

Here, the recycled material used in the present disclosure is an aluminum alloy disk in which an underlayer such as a Ni—P plating layer is present, and an aluminum alloy substrate for a magnetic disk corresponds to the intermediate material, while a magnetic disk corresponds to the finished product. Examples of these recycled materials include defective products, products out of specification, and used magnetic disks in the case of magnetic disks.

### 1. Recycled Material

First, an aluminum alloy substrate for a magnetic disk and a magnetic disk as recycled materials, which are used for at least part of an aluminum alloy material in the production of an aluminum alloy raw material, will be described. At least part means that all the aluminum alloy material may serve as these recycled materials, or part of the aluminum alloy material may serve as these recycled materials.

### 1-1. Aluminum Alloy Substrate for Magnetic Disk (Intermediate Material)

On a surface of the aluminum alloy substrate for a magnetic disk, an underlayer such as a Ni—P plating layer has been formed, and therefore, in order to reuse the aluminum alloy substrate for a magnetic disk for at least part of an aluminum alloy material not containing a large amount of Ni or P, it is important to separate most of the underlayer. A content of P in the Ni—P plating layer used as the aluminum alloy substrate for a magnetic disk is usually 15 mass % or more and 85 mass % or less. It is preferable that a thickness of the Ni—P-plating layer be 5 μm or more and 25 μm or less, and it is preferable that a thickness of the aluminum alloy substrate for a magnetic disk be 0.3 mm or more and 2.0 mm or less.

### 1-2. Magnetic Disk (Finished Product)

In the magnetic disk, a CoCrPt-based magnetic body layer or a protective film of a carbon-based material or the like has been formed on a surface of the aluminum alloy substrate for a magnetic disk serving as the intermediate material, but these magnetic body layer and protective film have been formed on the underlayer, so that most of these can be removed by removing the underlayer. On that account, a magnetic disk from which the underlayer has been removed can also be reused for at least part of an aluminum alloy material not containing a large amount of Ni or P. Even in the case of using the magnetic disk for at least part of an aluminum alloy material, it is important to remove much of the underlayer similarly to the aluminum alloy substrate for a magnetic disk.

### 1-3. Aluminum Alloy Material

The aluminum alloy material is a common material that has been adjusted to have prescribed alloy composition and is used as a raw material for producing an aluminum alloy ingot. In the aluminum alloy raw material produced by the present disclosure, an embodiment including such an aluminum alloy material and an aluminum alloy disk separated from the recycled material and an embodiment that is an aluminum alloy disk itself separated from the recycled material are included.

Next, a method for producing an aluminum alloy raw material according to an embodiment of the present disclosure, and further, a method for producing an aluminum alloy ingot using this aluminum alloy raw material, a method for producing an aluminum alloy plate using this aluminum alloy ingot, a method for producing an aluminum alloy substrate for plating using this aluminum alloy plate, a method for producing an aluminum alloy substrate for a magnetic disk using this aluminum alloy substrate for plating, a method for producing a magnetic disk using this aluminum alloy substrate for a magnetic disk, and a magnetic disk obtained by the method will be described in detail.

### 2. Method for Producing Aluminum Alloy Raw Material

As shown in FIG. 1, the aluminum alloy raw material is produced through a step of separation of an underlayer (Step S101).

In Step S101, as the recycled material, an intermediate material (aluminum alloy substrate for magnetic disk) or a finished product (magnetic disk) is reused for at least part of an aluminum alloy material, and it is heated and held at 480° C. or higher and 590° C. or lower for more than 1 hour, thereby separating the aluminum alloy disk and the underlayer from the recycled material (Step S101). The heating temperature is 480° C. or higher and 590° C. or lower, preferably 520° C. or higher and 590° C. or lower from the viewpoint of separability, and the holding time is more than 1 hour, preferably 2 hours or more, and due to this, separation of the aluminum alloy disk and the underlayer can be accelerated. This is because by the heating, Ni—P plating contained in the underlayer reacts with aluminum in the aluminum alloy disk to form a brittle intermediate layer containing Al, Ni, and P between the underlayer and the aluminum alloy disk, and therefore, cracks are generated starting from the intermediate layer containing Al, Ni, and P due to thermal stress during cooling after heating, and thus, the underlayer can be separated.

If the heating temperature is lower than 480° C. and/or the holding time is 1 hour or less in the separation step, the separation effects described above cannot be obtained. If the heating temperature exceeds 590° C., part of the aluminum alloy disk is melted, and peeling of the underlayer becomes difficult. The upper limit of the holding time is not particularly set, but if the holding time is increased, an aluminum portion in the aluminum alloy disk is peeled in a large amount, and therefore, the upper limit is preferably 30 hours.

In the separation step, it is preferable to carry out a cooling step of cooling the aluminum alloy material including the recycled material down to room temperature a plurality of times after heating. By carrying out the cooling step a plurality of times, separability can be enhanced. In the cooling step, further, it is preferable that a cooling rate in the temperature range of 400° C. or higher and 450° C. or lower be 30° C./h or higher. As described above, by the occurrence of thermal stress during cooling, cracks are generated starting from the intermediate layer containing Al, Ni, and P to separate the Ni—P plating contained in the underlayer, but if the cooling rate in the temperature range mentioned above is low, the thermal stress is small, and there is a fear of insufficient separation. On that account, in the cooling down to room temperature after heating, it is preferable that the cooling rate in the temperature range of 400° C. or higher and 450° C. or lower be 30° C./h or higher, it is more preferable that the cooling rate be 50° C./h or higher, and it is still more preferable that the cooling rate be 80° C./h or higher. The room temperature means a range of −10° C. or higher and 50° C. or lower.

In the cooling step, it is preferable to further make a physical impact on the aluminum alloy material including the recycled material. By making an impact on the aluminum alloy material including the recycled material, cracks in the intermediate layer containing Al, Ni, and P are liable to propagate, and the underlayer is easily peeled off. Examples of methods for making an impact include, but not limited to, a method of dropping the aluminum alloy material including the recycled material, which is a target, and a method of mechanically moving the target to contact it with another object, and an impact can be made on the aluminum alloy material including the recycled material in any way.

In the separation step, the heating rate during heating of the aluminum alloy material including the recycled material up to a prescribed temperature is not particularly limited, but it is preferable that the heating rate be 30° C./h or higher, it is more preferable that the heating rate be 50° C./h or higher, and it is still more preferable that the heating rate be 80° C./h or higher. In a furnace having been heated to a prescribed temperature in advance, the aluminum alloy material including the recycled material may be directly introduced.

Through the above step, an aluminum alloy raw material, particularly an aluminum alloy raw material for a magnetic disk, is produced.

### 3. Method for Producing Aluminum Alloy Ingot

The method for producing an aluminum alloy ingot includes a molten metal adjustment step of melting at least part of the aluminum alloy raw material obtained by the method mentioned above to adjust molten metal of an aluminum alloy, a molten metal heating-holding step of heating and holding the molten metal adjusted, and a casting step of casting the molten metal heated and held. Specifically, an aluminum alloy ingot is produced through such steps of adjustment of aluminum alloy components, adjustment/heating-holding of molten metal of an aluminum alloy (Step S102), and casting of an aluminum alloy (Step S103) as shown in FIG. 1.

### 3-1. Adjustment of Aluminum Alloy Components/Molten Metal Heating-Holding (Step S102)

In Step S102, the aluminum alloy raw material including the aluminum alloy disk separated from the recycled material in Step S101 is used, and it is heated and melted in accordance with conventional methods, thereby adjusting molten metal of an aluminum alloy having prescribed alloy composition.

### Ni (Nickel) Content

In the molten metal heating-holding step, it is preferable that a Ni content in the molten metal of an aluminum alloy be 0 mass % or more and 2.5 mass % or less. Ni is bonded to aluminum (Al) and the like to form an Al—Ni-based compound and causes large defects on a plated surface, so that the Ni content needs to be reduced. It is preferable that the Ni content in the molten metal be 2.5 mass % or less, it is more preferable that the Ni content be 0.5 mass % or less, and it is still more preferable that the Ni content be 0.1 mass % or less. Adjustment of the Ni content is performed in the aluminum alloy component adjustment step of heating and melting the raw material. For example, after the raw material in the molten metal is completely melted, the components of the molten metal are analyzed, and when the Ni content is high, an aluminum metal or the like is added to adjust the Ni content to a desired content.

### P (Phosphorus) Content

In the molten metal heating-holding step, it is preferable that a P content in the molten metal of an aluminum alloy be 0 mass % or more and 0.05 mass % or less. P is contained as a plating component partially remaining in the recycled material or contained in an aluminum alloy metal, and it is bonded to Mg (magnesium), which is generally contained in an aluminum alloy of a molten metal raw material, to form a Mg—P-based oxide, causes heterogeneous reaction only at that portion during plating treatment, and sometimes causes large defects on a plated surface. As a result, smoothness of the plated surface is decreased. By heating and holding the molten metal, part of the Mg—P-based oxide floats up on the molten metal surface and can be removed, but it is preferable that the content of P itself that is bonded to Mg be low. It is preferable that the P content in the molten metal be 0.05 mass % or less, and it is more preferable that the P content be 0.01 mass % or less. Since the P content in the molten metal is extremely low as compared with the Ni content, addition of an aluminum metal or the like to adjust the P content to a desired content is generally unnecessary. However, if the adjustment is needed, an aluminum metal or the like is added to adjust the P content to a desired content similarly to Ni.

### Mg (Magnesium) Content

In the molten metal heating-holding step, it is preferable that a Mg content in the molten metal of an aluminum alloy be 0 mass % or more and 6.5 mass % or less. As described above, Mg is bonded to P in the molten metal to form an Mg—P-based oxide, and therefore, it is preferable that its content be low similarly to P. It is preferable that the Mg content in the molten metal be 6.5 mass % or less, and it is more preferable that the Mg content be 4.5 mass % or less. When the Mg content is high, an aluminum metal or the like is added to adjust the Mg content to a desired content similarly to Ni.

### Metal Components in Molten Metal of Aluminum Alloy

Regarding the metal components contained in the molten metal of an aluminum alloy, in order to effectively remove or reduce a P component derived from electroless Ni—P plating components contained in the aluminum alloy substrate for a magnetic disk and the magnetic disk that are recycled materials, it is preferable to adjust a content of P itself and elements to form intermetallic compounds with P, such as Cu and Mg, as previously described.

On the other hand, elements other than Ni, P, Cu, and Mg and their contents are not particularly limited. Alloy composition contained in the molten metal of an aluminum alloy is, for example, the following one. The aluminum alloy contains, for example, Fe (iron) that is an essential element and optionally Mn (manganese), the total of contents of these Fe and Mn being in the range of 0.005 mass % or more and 7.00 mass % or less, further contains 0.5 mass % or more and 6.5 mass % or less of Mg, and optionally contains one or more metals selected from the group consisting of 0 mass % or more and 1.0 mass % or less of Si (silicon), 0 mass % or more and 0.7 mass % or less of Zn (zinc), 0 mass % or more and 0.30 mass % of Cr (chromium), and 0 mass % or more and 0.20 mass % of Zr (zirconium), with the balance being Al, inevitable impurities, and other trace components.

Examples of the inevitable impurities include Ti (titanium) and Ga (gallium) contained in the aluminum alloy, and examples of the other trace components include Co (cobalt) and Pt (platinum) contained in the plating, the magnetic body, and the like, which are unable to be completely separated from the recycled material. If the content of each element of these inevitable impurities and other trace components is 0.10 mass % or less and the total thereof is 0.30 mass % or less, they do not impair the working-effect of the present disclosure.

### 3-2. Heating-Holding of Molten Metal of Aluminum Alloy

Next, the molten metal heating-holding step of heating and holding the molten metal of an aluminum alloy will be described. In this step, the molten metal of an aluminum alloy is heated and held in a holding furnace under the conditions described later. When the content of P is high, the following adjustment is performed.

In order to reduce the content of P contained in the molten metal of an aluminum alloy adjusted, it is preferable to heat and hold the molten metal of an aluminum alloy at a temperature of 700° C. or higher and 850° C. or lower for 3 hours or more in the molten metal heating-holding step.

Part of P contained in the molten metal changes to an oxide such as a Mg—P-based oxide due to the molten metal heating-holding step and floats up on the molten metal surface. By removing this floating oxide and the like by a method of scooping up or the like prior to casting, the content of P in the molten metal can be reduced. It is preferable that the heating temperature be 700° C. or higher and 850° C. or lower, and from the viewpoint of energy saving in power consumption, it is more preferable that the heating temperature be 700° C. or higher and 755° C. or lower. It is preferable that the holding time be 3 hours or more, and from the viewpoint of accelerating production of a Mg—P-based oxide or the like, it is more preferable that the holding time be 20 hours or more. Particularly, the holding time is important from the viewpoint of an effect of accelerating production of a Mg—P-based oxide or the like. If the heating temperature is lower than 700° C. and/or the holding time is less than 3 hours, there is a fear that a sufficient effect of accelerating production of a Mg—P-based oxide or the like is not obtained. If the heating temperature exceeds 850° C., the effect of accelerating production of a Mg—P-based oxide or the like is saturated, and such a temperature is not economical. The upper limit of the holding time is not particularly limited, but if the holding time exceeds 72 hours, the effect of accelerating production of a Mg—P-based oxide or the like is saturated, and such a holding time is not economical.

### 3-3. Casting of Aluminum Alloy (Step S103)

Next, the casting step for the aluminum alloy will be described. The molten metal of an aluminum alloy heated and held is subjected to in-line degassing treatment or in-line filtration treatment described later as needed, and thereafter cast into an aluminum alloy ingot by a semi-continuous casting method (DC casting method), a mold casting method, a continuous casting method (CC method) or the like (Step S103). In the DC casting method, from the molten metal poured through a spout, heat is taken away by a bottom block, a wall of a water-cooled mold, and cooling water directly discharged to the outer peripheral part of an ingot (ingot), and the molten metal is solidified and pulled down as an ingot. In the mold casting method, from the molten metal poured in a hollow mold made of cast iron or the like, heat is taken away by a wall of the mold, and the molten metal is solidified to make an ingot. In the CC casting method, between a pair of rolls (or belt casters, block casters), the molten metal is fed through a casting nozzle, and it is directly cast into a thin plate due to heat removal by the rolls.

It is preferable to subject the molten metal having been heated and held in the molten metal heating-holding step to in-line degassing treatment or in-line filtration treatment in accordance with a conventional method before the molten metal is subjected to the casting step. As an in-line degassing treatment device, degassing devices that are commercially available under tradenames such as SNIF or ALPUR can be used. In these in-line degassing treatment devices, with blowing argon gas or a mixed gas of argon and nitrogen or the like into the molten metal, a bladed rotator is rotated at a high speed to feed the gas into the molten metal as fine bubbles. Due to this, removal of dehydrogenation gas and inclusions can be carried out in-line in a short time. For the in-line filtration treatment, a ceramic tube filter, a ceramic foam filter, an alumina ball filter, or the like is used, and inclusions are removed by cake filtration mechanism, filter media filtration mechanism, or the like.

Through the above step, an aluminum alloy ingot, particularly an aluminum alloy ingot for a magnetic disc, is produced.

### 4. Method for Producing Aluminum Alloy Plate

The method for producing an aluminum alloy plate includes a homogenization treatment step of optionally heat treating the aluminum alloy ingot obtained by the method mentioned above, a hot rolling step of hot rolling the aluminum alloy ingot optionally homogenized, and a cold rolling step of cold rolling a hot rolled plate obtained by the hot rolling. Specifically, the aluminum alloy plate is produced through such steps of homogenization treatment of an aluminum alloy ingot (Step S104), hot rolling (Step S105), and cold rolling (Step S106) as shown in FIG. 1.

### 4-1. Homogenization Treatment (Step S104)

The cast aluminum alloy ingot is subjected to homogenization treatment as needed (Step S104). When the homogenization treatment is performed, the aluminum alloy ingot is heat treated preferably under the conditions of a heating temperature of 480° C. or higher and 560° C. or lower for 1 hour or more, and more preferably a heating temperature of 500° C. or higher and 550° C. or lower for 2 hours or more. If the heating temperature is lower than 480° C., or if the heating time is less than 1 hour, a sufficient homogenization effect may not be obtained. At a heating temperature exceeding 560° C., there is a fear of melting of the aluminum alloy ingot. The upper limit of the heating time is not particularly limited, but if it exceeds 48 hours, the homogenization effect is saturated, and there is a fear of leading to a decrease in productivity.

### 4.2. Hot Rolling (Step S105)

Thereafter, the cast aluminum alloy ingot or a homogenization treated aluminum alloy ingot in the case where homogenization treatment has been performed is subjected to hot rolling to make a hot rolled plate (Step S105). The conditions of the hot rolling are not particularly limited, but it is preferable that a hot rolling onset temperature be 300° C. or higher and 500° C. or lower, and it is more preferable that the onset temperature be 320° C. or higher and 480° C. or lower. It is preferable that a hot rolling end temperature be 260° C. or higher and 400° C. or lower, and it is more preferable that the end temperature be 280° C. or higher and 380° C. or lower. If the hot rolling onset temperature is lower than 300° C., processability due to the hot rolling cannot be secured, and if the hot rolling onset temperature exceeds 500° C., crystal grains are coarsened, and adhesion of plating is sometimes decreased. If the hot rolling end temperature is lower than 260° C., processability due to the hot rolling cannot be secured, and if the hot rolling end temperature exceeds 400° C., crystal grains are coarsened, and adhesion of plating is sometimes decreased. Regarding the hot rolling, hot rolling of the ingot is usually carried out at the hot rolling onset temperature for a hot rolling time in the range of 0.5 hour or more and 10.0 hours or less after the heating-holding. If homogenization treatment is carried out, this heating-holding may be replaced by the homogenization treatment.

### 4-3. Cold Rolling (Step S106)

Thereafter, the resulting hot rolled plate is cold rolled to preferably make a cold rolled plate having a thickness of 0.4 mm or more and 2.0 mm or less, more preferably 0.6 mm or more and 2.0 mm or less (Step S106). In other words, after completion of the hot rolling, the hot rolled plate is finished to a desired product plate thickness by cold rolling. The conditions of the cold rolling are not particularly limited, but they may be determined according to a plate strength or a plate thickness of a required product, and it is preferable that a rolling ratio be 20% or more and 90% or less, and it is more preferable that the rolling ratio be 20% or more and 80% or less. If this rolling ratio is less than 20%, crystal grains are coarsened in pressure flattening annealing of a disk blank described later, and adhesion of plating is sometimes decreased. On the other hand, if this rolling ratio exceeds 90%, the production time becomes longer, and there is a fear of leading to a decrease in productivity.

In order to secure good cold rolling processability, annealing treatment may be optionally performed before the cold rolling or during the cold rolling. When annealing treatment is performed, it is preferable to perform, for example, annealing of batch process under the conditions of an annealing temperature of 300° C. or higher and 450° C. or lower and an annealing time of 0.1 hour or more and 10 hours or less, and it is more preferable to perform the annealing under the conditions of an annealing temperature of 300° C. or higher and 380° C. or lower and an annealing time of 1 hour or more and 5 hours or less. If the annealing temperature is lower than 300° C. and/or the annealing time is less than 0.1 hour, a sufficient annealing effect may not be obtained. If the annealing temperature exceeds 450° C., crystal grains are coarsened to sometimes decrease adhesion of plating, and if the annealing time exceeds 10 hours, the production time becomes longer, and there is a fear of leading to a decrease in productivity.

On the other hand, it is preferable to perform continuous annealing under the conditions of an annealing temperature of 400° C. or higher and 500° C. or lower and holding of 0 to 60 seconds, and it is more preferable to perform the annealing under the conditions of an annealing temperature of 450° C. or higher and 500° C. or lower and holding of 0 to 30 seconds. If the annealing temperature is lower than 400° C., a sufficient annealing effect may not be obtained, and if the annealing temperature exceeds 500° C., crystal grains are coarsened, and adhesion of plating is sometimes decreased. If the annealing time exceeds 60 seconds, crystal grains are coarsened, and adhesion of plating is sometimes decreased. A holding time of 0 second means that cooling is performed immediately after a desired annealing temperature is reached.

Through the above steps, an aluminum alloy plate, particularly an aluminum alloy plate for a magnetic disk, is made.

### 5. Method for Producing Aluminum Alloy Substrate for Plating.

The method for producing an aluminum alloy substrate for plating includes a processing step of processing the aluminum alloy plate obtained by the method mentioned above into an annular disk blank, a pressure annealing step of pressure flattening the annular disk blank, and a cutting/grinding work step of subjecting the annular disk blank pressure flattened to cutting work and grinding work. Specifically, the aluminum alloy substrate for plating is produced through such steps of punching out the aluminum alloy plate into an annular disk blank (hereinafter, sometimes referred to as “disk blank”) (Step S107), pressure flattening-annealing of this disk blank (Step S108), subsequent cutting work and grinding work (Step S109: “cutting/grinding work step”), and further strain relieving heat treatment as necessary (Step S110) as shown in FIG. 1.

### 5-1. Making of Annular Disk Blank (Step S107)

For processing the aluminum alloy plate obtained as above into an aluminum alloy substrate, first, the aluminum alloy plate is punched out annularly to make an annular disk blank (Step S107).

### 5-2. Pressure Annealing (Step S108)

Thereafter, the disk blank is subjected to pressure annealing in the atmosphere at a temperature of 300° C. or higher and 450° C. or lower for 30 minutes or more, preferably at a temperature of 300° C. or higher and 380° C. or lower for 60 minutes or more, to make a flattened disk blank (Step S108). If the treatment temperature of the pressure annealing is lower than 300° C. and/or the treatment time is less than 30 minutes, an effect of flattening may not be sufficiently obtained. If the treatment temperature exceeds 450° C., crystal grains are coarsened, and adhesion of plating is sometimes decreased. The upper limit of the treatment time is not particularly limited, but if it exceeds 24 hours, the production time becomes longer, and there is a fear of leading to a decrease in productivity. The pressure in the pressure annealing is usually 0.1 MPa or more and 3.0 MPa or less.

### 5-3. Cutting Work/Grinding Work (Step S109), Strain Relieving Heat Treatment (Step S110)

Thereafter, the disk blank flattened in the cutting/grinding work step is subjected to cutting work and grinding work (Step S109). After that, strain relieving heat treatment to relieve strain of the disk blank is optionally carried out under the conditions of a temperature of 200° C. or higher and 290° C. or lower for 0.1 hour or more and 10.0 hours or less (Step S110).

Through the above steps, an aluminum alloy substrate for plating is made.

### 6. Method for Producing Aluminum Alloy Substrate for Magnetic Disk

The method for producing an aluminum alloy substrate for a magnetic disk includes a plating pretreatment step of subjecting the aluminum alloy substrate for plating obtained by the method mentioned above to degreasing, etching, and zincate treatment, and a base plating treatment step of subjecting a surface of the aluminum alloy substrate subjected to the plating pretreatment to electroless Ni—P plating treatment and polishing the surface subjected to the plating treatment. Such an aluminum alloy substrate for a magnetic disk is produced through steps of plating pretreatment of the aluminum alloy substrate for plating (Step S111) and base (Ni—P) plating treatment (with polishing) (Step S112), as shown in FIG. 1.

### 6-1. Plating Pretreatment (Step S111)

The aluminum alloy substrate for plating made as above is subjected to degreasing, etching, and zincate treatment (Zn substitution treatment) as plating pretreatment (Step S111). It is preferable to perform degreasing using a degreasing liquid, such as commercially available AD-68F (manufactured by C. Uyemura & Co., Ltd.), under the conditions of a degreasing temperature of 40° C. or higher and 70° C. or lower, a degreasing time of 3 minutes or more and 10 minutes or less, and a degreasing liquid concentration of 200 mL/L or more and 800 mL/L or less, and it is more preferable to perform degreasing under the conditions of a degreasing temperature of 45° C. or higher and 65° C. or lower, a degreasing time of 4 minutes or more and 8 minutes or less, and a degreasing liquid concentration of 300 mL/L or more and 700 mL/L or less. If the degreasing temperature is lower than 40° C., the degreasing time is less than 3 minutes, and/or the degreasing liquid concentration is less than 200 mL/L, a sufficient degreasing effect may not be obtained. If the degreasing temperature exceeds 70° C., the degreasing time exceeds 10 minutes, and/or the degreasing liquid concentration exceeds 800 mL/L, smoothness of a surface of the aluminum alloy substrate is decreased, and pits occurs after the plating treatment to sometimes decrease smoothness.

It is preferable to perform etching using an etching liquid, such as commercially available AD-107F (manufactured by C. Uyemura & Co., Ltd.), under the conditions of an etching temperature of 50° C. or higher and 75° C. or lower, an etching time of 0.5 minute or more and 5 minutes or less, and an etching liquid concentration of 20 ml/L or more and 100 mL/L or less, and it is more preferable to perform etching under the conditions of an etching temperature of 55° C. or higher and 70° C. or lower, an etching time of 0.5 minute or more and 3 minutes or less, and an etching liquid concentration of 40 mL/L or more and 100 mL/L or less. If the etching temperature is lower than 50° C., the etching time is less than 0.5 minute, and/or the etching liquid concentration is less than 20 mL/L, a sufficient etching effect may not be obtained. If the etching temperature exceeds 75° C., the etching time exceeds 5 minutes, and/or the etching liquid concentration exceeds 100 mL/L, smoothness of a surface of the aluminum alloy substrate is decreased, and pits occurs after the plating treatment to sometimes decrease smoothness. Between the etching treatment and zincate treatment described later, usual desmutting treatment may be carried out.

It is preferable to perform zincate treatment using a zincate treatment liquid, such as commercially available AD-301F-3X (manufactured by C. Uyemura & Co., Ltd.), under the conditions of a zincate treatment temperature of 10° C. or higher and 35° C. or lower, a zincate treatment time of 0.1 minute or more and 5 minutes or less, and a zincate treatment liquid concentration of 100 mL/L or more and 500 mL/L or less, and it is more preferable to perform zincate treatment under the conditions of a zincate treatment temperature of 15° C. or higher and 30° C. or lower, a zincate treatment time of 0.1 minute or more and 2 minutes or less, and a zincate treatment liquid concentration of 200 mL/L or more and 400 ml/L or less. If the zincate treatment temperature is lower than 10° C., the zincate treatment time is less than 0.1 minute, and/or the zincate treatment liquid concentration is less than 100 mL/L, the zincate film becomes non-uniform, and pits occurs after the plating treatment to sometimes decrease smoothness. If the zincate treatment temperature exceeds 35° C., the zincate treatment time exceeds 5 minutes, and/or the zincate treatment liquid concentration exceeds 500 mL/L, the zincate film becomes non-uniform, and pits occurs after the plating treatment to sometimes decrease smoothness.

6-2. Base (Ni—P) Plating Treatment (with Polishing) (Step S112)

Thereafter, the surface of the aluminum alloy substrate for plating, which has been subjected to zincate treatment, is subjected to electroless Ni—P plating treatment as surface treatment, and subsequently, polishing of its surface is performed (Step S112). It is preferable to perform the electroless Ni—P plating treatment using a plating solution, such as commercially available NIMUDEN HDX (manufactured by C. Uyemura & Co., Ltd.), under the conditions of a plating treatment temperature of 80° C. or higher and 95° C. or lower, a plating treatment time of 30 minutes or more and 180 minutes or less, and a Ni concentration of 3 g/L or more and 10 g/L or less in the plating solution, and it is more preferable to perform the plating treatment under the conditions of a plating treatment temperature of 85° C. or higher and 95° C. or lower, a plating treatment time of 60 minutes or more and 120 minutes or less, and a Ni concentration of 4 g/L or more and 9 g/L or less in the plating solution. If the plating treatment temperature is lower than 80° C., and/or the Ni concentration in the plating solution is less than 3 g/L, a growth rate of plating is low, and there is a fear of leading to a decrease in productivity. If the plating treatment time is less than 30 minutes, a large number of defects occur on a plated surface, and smoothness of the plated surface is sometimes decreased. On the other hand, if the plating treatment temperature exceeds 95° C., and/or the Ni concentration in the plating solution exceeds 10 g/L, plating grows heterogeneously, and therefore, plating smoothness is sometimes decreased. If the plating treatment time exceeds 180 minutes, the production time becomes longer, and there is a fear of leading to a decrease in productivity. On the base (Ni—P) plating treated surface, polishing treatment is further performed.

By these plating pretreatment and base (Ni—P) plating treatment (with polishing), an aluminum alloy substrate for a magnetic disk is made.

### 7. Method for Producing Magnetic Disk

The method for producing a magnetic disk includes a magnetism imparting step of allowing a magnetic body to adhere to a surface of the aluminum alloy substrate for a magnetic disk obtained by the method mentioned above to form a magnetic body layer. Such a magnetic disk is made by allowing a magnetic body to adhere to a surface of an aluminum alloy substrate for a magnetic disk, which has been subjected to surface treatment, (Step S113), as shown in FIG. 1.

After the electroless Ni—P plating treatment including polishing treatment, a magnetic body is allowed to adhere onto the Ni—P plating layer by sputtering to form a magnetic body layer (Step S113). The magnetic body layer may be a single layer, or may be formed of a plurality of layers having compositions different from one another. After the sputtering is carried out, a protective layer composed of a carbon-based material may be formed on the magnetic body layer by CVD, and a lubricant layer may be formed by applying a lubricant onto the protective layer, as needed.

Through the above step, a magnetic disk having a Ni—P plating layer on a surface of the aluminum alloy substrate for a magnetic disk and a magnetic body layer formed on the Ni—P plating layer can be made. Since the magnetic disk obtained by such a method for producing a magnetic disk is made by using the recycled material mentioned above, it is beneficial as a magnetic disk that is excellent in reduction of environmental burden.

Hereinbefore, the method for producing an aluminum alloy raw material, the method for producing an aluminum alloy ingot, the method for producing an aluminum alloy plate, the method for producing an aluminum alloy substrate for plating, the method for producing an aluminum alloy substrate for a magnetic disk, and the method for producing a magnetic disk, which are according to the present embodiments, are described, but the present disclosure is not limited to the above embodiments, and various modifications and changes can be made based on the technical idea of the present disclosure.

On the basis of the above embodiments, the present disclosure relates to {1} to {14} below.

{1}

A method for producing an aluminum alloy raw material comprising a separation step of reusing, as a recycled material, at least one of an intermediate material and a finished product each comprising an aluminum alloy disk and an underlayer, for at least part of an aluminum alloy material and heating the aluminum alloy material comprising the recycled material to separate the aluminum alloy disk and the underlayer, wherein the aluminum alloy material comprising the recycled material is heated and held at 480° C. or higher and 590° C. or lower for more than 1 hour.

{2}

The method for producing an aluminum alloy raw material according to {1} above, wherein in the separation step, a cooling step of cooling the aluminum alloy material comprising the recycled material down to room temperature is carried out a plurality of times after heating.

{3}

The method for producing an aluminum alloy raw material according to {2} above, wherein in the cooling step, a cooling rate in a temperature range of 400° C. or higher and 450° C. or lower is 30° C./h or higher.

{4}

The method for producing an aluminum alloy raw material according to {2} or {3} above, wherein in the cooling step, a physical impact is further made on the aluminum alloy material comprising the recycled material.

{5}

A method for producing an aluminum alloy ingot comprising a molten metal adjustment step of melting at least part of an aluminum alloy raw material obtained by the method according to any one of {1} to {4} above to adjust molten metal of an aluminum alloy, a molten metal heating-holding step of heating and holding the molten metal adjusted, and a casting step of casting the molten metal heated and held.

{6}

The method for producing an aluminum alloy ingot according to {5} above, wherein in the molten metal heating-holding step, a Ni content in the molten metal of an aluminum alloy is 2.5 mass % or less.

{7}

A method for producing an aluminum alloy plate comprising a homogenization treatment step of optionally heat treating an aluminum alloy ingot obtained by the method according to {5} or {6} above, a hot rolling step of hot rolling the aluminum alloy ingot optionally homogenized, and a cold rolling step of cold rolling a hot rolled plate obtained by the hot rolling.

{8}

A method for producing an aluminum alloy substrate for plating comprising a processing step of processing an aluminum alloy plate obtained by the method according to {7} above into an annular disk blank, a pressure annealing step of pressure flattening the annular disk blank, and a cutting/grinding work step of subjecting the annular disk blank pressure flattened to cutting work and grinding work.

{9}

A method for producing an aluminum alloy substrate for a magnetic disk comprising a plating pretreatment step of subjecting an aluminum alloy substrate for plating obtained by the method according to {8} above to degreasing, etching, and zincate treatment, and a base plating treatment step of subjecting a surface of the aluminum alloy substrate subjected to the plating pretreatment to electroless Ni—P plating treatment and polishing the surface subjected to the plating treatment.

{10}

A method for producing a magnetic disk comprising a magnetism imparting step of allowing a magnetic body to adhere to a surface of an aluminum alloy substrate for a magnetic disk obtained by the method according to {9} above to form a magnetic body layer.

{11}

A magnetic disk obtained by the method according to {10} above.

{12}

A method for producing an aluminum alloy plate comprising:
a separation step of reusing, as a recycled material, at least one of an intermediate material and a finished product each comprising an aluminum alloy disk and an underlayer, for at least part of an aluminum alloy material and heating the aluminum alloy material comprising the recycled material to separate the aluminum alloy disk and the underlayer,
a molten metal adjustment step of melting at least part of an aluminum alloy raw material obtained by the separation step to adjust molten metal of an aluminum alloy,
a molten metal heating-holding step of heating and holding the molten metal adjusted,
a casting step of casting the molten metal heated and held to make an aluminum alloy ingot,
a homogenization treatment step of optionally heat treating the aluminum alloy ingot obtained,
a hot rolling step of hot rolling the aluminum alloy ingot optionally homogenized, and
a cold rolling step of cold rolling a hot rolled plate obtained by the hot rolling, wherein
the aluminum alloy material comprising the recycled material is heated and held at 480° C. or higher and 590° C. or lower for more than 1 hour.
   {13}

A method for producing an aluminum alloy plate comprising:
a separation step of reusing, as a recycled material, at least one of an intermediate material and a finished product each comprising an aluminum alloy disk and an underlayer, for at least part of an aluminum alloy material and heating the aluminum alloy material comprising the recycled material to separate the aluminum alloy disk and the underlayer,
a molten metal adjustment step of melting at least part of an aluminum alloy raw material obtained by the separation step to adjust molten metal of an aluminum alloy,
a molten metal heating-holding step of heating and holding the molten metal adjusted,
a casting step of casting the molten metal heated and held to make an aluminum alloy ingot,
a homogenization treatment step of optionally heat treating the aluminum alloy ingot obtained,
a hot rolling step of hot rolling the aluminum alloy ingot optionally homogenized, and
a cold rolling step of cold rolling a hot rolled plate obtained by the hot rolling, wherein
a separation ratio between the aluminum alloy disk and the underlayer after the separation step is 100% or more.
   {14}

A method for producing a magnetic disk comprising: a processing step of processing an aluminum alloy plate obtained by the method according to {12} or {13} above into an annular disk blank,
a pressure annealing step of pressure flattening the annular disk blank,
a cutting/grinding work step of subjecting the annular disk blank pressure flattened to cutting work and grinding work to make an aluminum alloy substrate for plating,
a plating pretreatment step of subjecting the aluminum alloy substrate for plating obtained to degreasing, etching, and zincate treatment,
a base plating treatment step of subjecting a surface of the aluminum alloy substrate subjected to the plating pretreatment to electroless Ni—P plating treatment and polishing the surface subjected to the plating treatment, and
a magnetism imparting step of allowing a magnetic body to adhere to a surface of an aluminum alloy substrate for a magnetic disk obtained by the base plating treatment step to form a magnetic body layer.

### Examples

Hereinafter, the present disclosure will be described in more detail with reference to Examples, but the present disclosure is not limited thereto.

An aluminum alloy substrate for a magnetic disk (referred to as “aluminum alloy substrate” hereinafter) was used as a recycled material, and this was subjected to heating-holding and cooling under the conditions shown in Table 1 to separate an underlayer, thereby producing an aluminum alloy raw material (aluminum alloy disk). In Table 1, “temperature” and “time” represent “heating temperature” and “holding time” in the separation step, respectively; “the number of cooling times” represents the number of times to cool the aluminum alloy substrate down to room temperature (25° C.) in the cooling step after heating; and “cooling rate” means a cooling rate in the temperature range of 400° C. or higher and 450° C. or lower. In the cooling step, a physical impact was made by dropping the target (aluminum alloy substrate) from a height of 1 m.

A P content in a Ni—P plating layer having adhered to the aluminum alloy substrate used as a recycled material was about 12 mass % based on the total mass of the aluminum alloy substrate. Alloy composition of an aluminum alloy used for an aluminum alloy substrate of the aluminum alloy substrate for a magnetic disk had a total content of Fe and Mn in the range of 0.015 mass % or more and 0.030 mass % or less, contained 3.8 mass % or more and 4.5 mass % or less of Mg, contained 0.01 mass % or less of Ni, further contained one or two or more metals selected from the group consisting of Si: 0.03 mass % or less, Zn: 0.30 mass % or more and 0.40 mass % or less, Cr: 0.04 mass % or more and 0.06 mass % or less, and Cu: 0.005 mass % or more and 0.025 mass % or less, with the balance being Al, inevitable impurities, and trace components.

For the evaluation of separability, a weight of the aluminum alloy disk (Ws) after heating was measured, then a difference between this weight and a weight of an aluminum alloy portion (Wa) of the aluminum alloy substrate before heating, which had been determined by calculation, (S1=Ws−Wa), was calculated, then a difference between the resulting value and a weight of the underlayer (Wp), such as plating, on the aluminum alloy substrate before heating, which had been determined by calculation, (S2=Wp−S1), was calculated, and a value obtained by dividing the resulting value by Wp, (S2/Wp), was multiplied by 100 to determine a separation ratio (%). The results are set forth in Table 1. The outer peripheral part and the inner peripheral part of the aluminum alloy substrate had chamfered portions, but the chamfered portions had a small degree of influence as compared with the weight of the total, so that the calculation was made assuming that there was no chamfered portion. A separation ratio exceeding 100% means that not only the underlayer but also part of an aluminum alloy peels off from the recycled material, but this is only a small part of the whole of the aluminum alloy disk, and therefore, such a case was evaluated as excellent in recyclability on the ground that the underlayer had been peeled off.

TABLE 1

| | | | The | | Making | Sep- |
|---|---|---|---|---|---|---|
| | Temp- | | number | Cooling | of | aration |
| | erature | Time | of cooling | rate | physical | ratio |
| | (° C.) | (h) | times | (° C./h) | impact | (%) |
| Example 1 | 500 | 2 | Once | 45000 | No | 101 |
| Example 2 | 525 | 2 | Once | 45000 | No | 117 |
| Example 3 | 575 | 2 | Once | 45000 | No | 164 |
| Example 4 | 550 | 2 | Once | 45000 | No | 143 |
| Example 5 | 550 | 4 | Once | 45000 | No | 176 |
| Example 6 | 550 | 8 | Once | 45000 | No | 161 |
| Example 7 | 550 | 24 | Once | 45000 | No | 172 |
| Example 8 | 550 | 2 | Twice | 45000 | No | 172 |
| Example 9 | 550 | 2 | Once | 100 | No | 147 |
| Example 10 | 550 | 2 | Three times | 45000 | No | 196 |
| Example 11 | 550 | 2 | Once | 25 | No | 120 |
| Example 12 | 550 | 2 | Once | 45000 | Yes | 196 |
| Example 13 | 550 | 2 | Twice | >45000 | No | 141 |
| Comparative | 450 | 2 | Once | 45000 | No | 0 |
| Example 1 | | | | | | |
| Comparative | 475 | 2 | Once | 45000 | No | 56 |
| Example 2 | | | | | | |
| Comparative | 500 | 1 | Once | 45000 | No | 79 |
| Example 3 | | | | | | |
| Comparative | 550 | 1 | Once | 45000 | No | 65 |
| Example 4 | | | | | | |

As shown in Table 1, in Examples 1 to 13, the separation ratio was 100% or more, and a result of excellent recyclability was obtained. In particular, as the heating time and the holding time were increased, the separation ratio increased, and recyclability was more excellent. By setting the cooling rate to 30° C./h or higher in the temperature range of 400° C. or higher and 450° C. or lower, the separation ratio increased, and recyclability was improved. Furthermore, also when a physical impact was made on the aluminum alloy substrate in the cooling step, the separation ratio increased, and recyclability was improved.

In contrast with this, in Comparative Examples 1 to 4, the heating temperature was too low, or the holding time was insufficient, therefore the separation ratio became less than 100%, and the result was inferior in recyclability. Particularly in Comparative Example 1, since the heating temperature was extremely low, the underlayer was unable to be separated.

### INDUSTRIAL APPLICABILITY

By the present disclosure, an aluminum alloy raw material having excellent recyclability can be provided. Moreover, using such an aluminum alloy raw material having excellent recyclability, an aluminum alloy ingot having excellent recyclability, an aluminum alloy plate, an aluminum alloy substrate for plating, an aluminum alloy substrate for a magnetic disk, and a magnetic disk can be provided.

What is claimed is:

1. A method for producing an aluminum alloy raw material comprising a separation step of reusing, as a recycled material, at least one of an intermediate material and a finished product each comprising an aluminum alloy disk and an underlayer, for at least part of an aluminum alloy material and heating the aluminum alloy material comprising the recycled material to separate the aluminum alloy disk and the underlayer, wherein the aluminum alloy material comprising the recycled material is heated and held at 480° C. or higher and 590° C. or lower for more than 1 hour.

2. The method for producing an aluminum alloy raw material according to claim 1, wherein in the separation step, a cooling step of cooling the aluminum alloy material comprising the recycled material down to room temperature is carried out a plurality of times after heating.

3. The method for producing an aluminum alloy raw material according to claim 2, wherein in the cooling step, a cooling rate in a temperature range of 400° C. or higher and 450° C. or lower is 30° C./h or higher.

4. The method for producing an aluminum alloy raw material according to claim 2, wherein in the cooling step, a physical impact is further made on the aluminum alloy material comprising the recycled material.

5. A method for producing an aluminum alloy ingot comprising a molten metal adjustment step of melting at least part of an aluminum alloy raw material obtained by the method according to claim 1 to adjust molten metal of an aluminum alloy, a molten metal heating-holding step of heating and holding the molten metal adjusted, and a casting step of casting the molten metal heated and held.

6. The method for producing an aluminum alloy ingot according to claim 5, wherein in the molten metal heating-holding step, a Ni content in the molten metal of an aluminum alloy is 2.5 mass % or less.

7. A method for producing an aluminum alloy plate comprising a homogenization treatment step of optionally heat treating an aluminum alloy ingot obtained by the method according to claim 5, a hot rolling step of hot rolling the aluminum alloy ingot optionally homogenized, and a cold rolling step of cold rolling a hot rolled plate obtained by the hot rolling.

8. A method for producing an aluminum alloy substrate for plating comprising a processing step of processing an aluminum alloy plate obtained by the method according to claim 7 into an annular disk blank, a pressure annealing step of pressure flattening the annular disk blank, and a cutting/grinding work step of subjecting the annular disk blank pressure flattened to cutting work and grinding work.

9. A method for producing an aluminum alloy substrate for a magnetic disk comprising a plating pretreatment step of subjecting an aluminum alloy substrate for plating obtained by the method according to claim 8 to degreasing, etching, and zincate treatment, and a base plating treatment step of subjecting a surface of the aluminum alloy substrate subjected to the plating pretreatment to electroless Ni—P plating treatment and polishing the surface subjected to the plating treatment.

10. A method for producing a magnetic disk comprising a magnetism imparting step of allowing a magnetic body to adhere to a surface of an aluminum alloy substrate for a magnetic disk obtained by the method according to claim 9 to form a magnetic body layer.

11. A magnetic disk obtained by the method according to claim 10.

12. A method for producing an aluminum alloy plate comprising:
a separation step of reusing, as a recycled material, at least one of an intermediate material and a finished product each comprising an aluminum alloy disk and an underlayer, for at least part of an aluminum alloy material and heating the aluminum alloy material comprising the recycled material to separate the aluminum alloy disk and the underlayer,
a molten metal adjustment step of melting at least part of an aluminum alloy raw material obtained by the separation step to adjust molten metal of an aluminum alloy,
a molten metal heating-holding step of heating and holding the molten metal adjusted,
a casting step of casting the molten metal heated and held to make an aluminum alloy ingot,
a homogenization treatment step of optionally heat treating the aluminum alloy ingot obtained,
a hot rolling step of hot rolling the aluminum alloy ingot optionally homogenized, and
a cold rolling step of cold rolling a hot rolled plate obtained by the hot rolling, wherein
the aluminum alloy material comprising the recycled material is heated and held at 480° C. or higher and 590° C. or lower for more than 1 hour.

13. A method for producing an aluminum alloy plate comprising:
a separation step of reusing, as a recycled material, at least one of an intermediate material and a finished product each comprising an aluminum alloy disk and an underlayer, for at least part of an aluminum alloy material and heating the aluminum alloy material comprising the recycled material to separate the aluminum alloy disk and the underlayer,
a molten metal adjustment step of melting at least part of an aluminum alloy raw material obtained by the separation step to adjust molten metal of an aluminum alloy,
a molten metal heating-holding step of heating and holding the molten metal adjusted,
a casting step of casting the molten metal heated and held to make an aluminum alloy ingot,
a homogenization treatment step of optionally heat treating the aluminum alloy ingot obtained,
a hot rolling step of hot rolling the aluminum alloy ingot optionally homogenized, and
a cold rolling step of cold rolling a hot rolled plate obtained by the hot rolling, wherein
a separation ratio between the aluminum alloy disk and the underlayer after the separation step is 100% or more.

14. A method for producing a magnetic disk comprising:
a processing step of processing an aluminum alloy plate obtained by the method according to claim 12 into an annular disk blank,
a pressure annealing step of pressure flattening the annular disk blank,
a cutting/grinding work step of subjecting the annular disk blank pressure flattened to cutting work and grinding work to make an aluminum alloy substrate for plating,
a plating pretreatment step of subjecting the aluminum alloy substrate for plating obtained to degreasing, etching, and zincate treatment,
a base plating treatment step of subjecting a surface of the aluminum alloy substrate subjected to the plating pretreatment to electroless Ni—P plating treatment and polishing the surface subjected to the plating treatment, and
a magnetism imparting step of allowing a magnetic body to adhere to a surface of an aluminum alloy substrate for a magnetic disk obtained by the base plating treatment step to form a magnetic body layer.

15. A method for producing a magnetic disk comprising:
a processing step of processing an aluminum alloy plate obtained by the method according to claim 13 into an annular disk blank,
a pressure annealing step of pressure flattening the annular disk blank,
a cutting/grinding work step of subjecting the annular disk blank pressure flattened to cutting work and grinding work to make an aluminum alloy substrate for plating,
a plating pretreatment step of subjecting the aluminum alloy substrate for plating obtained to degreasing, etching, and zincate treatment,
a base plating treatment step of subjecting a surface of the aluminum alloy substrate subjected to the plating pretreatment to electroless Ni—P plating treatment and polishing the surface subjected to the plating treatment, and
a magnetism imparting step of allowing a magnetic body to adhere to a surface of an aluminum alloy substrate for a magnetic disk obtained by the base plating treatment step to form a magnetic body layer.
